(19) United States
(12) Patent Application Publication
(10) Pub. No.: US 2014/0298002 A1
(43) Pub. Date: Oct. 2, 2014

(54) METHOD AND DEVICE FOR IDENTIFYING A DISK BOOT SECTOR VIRUS, AND STORAGE MEDIUM

(71) Applicant: TENCENT TECHNOLOGY (SHENZHEN) COMPANY LIMITED, Shenzhen (CN)

(72) Inventor: Wen TAN, Shenzhen (CN)

(21) Appl. No.: 14/304,777

(22) Filed: Jun. 13, 2014

Related U.S. Application Data
(63) Continuation of application No. PCT/CN2013/088142, filed on Nov. 29, 2013.

(30) Foreign Application Priority Data
Jan. 28, 2013 (CN) 201310031901.2

(51) Int. Cl. G06F 21/57

(52) U.S. Cl. CPC G06F 21/575
USPC 713/2

(57) ABSTRACT

The present disclosure discloses a method and a device for identifying a disk boot sector virus, and a storage medium. The method comprises steps of: obtaining a known behavior pattern that is prestored, and obtaining a master boot record (MBR) and disk data called when the MBR is executed; establishing a simulated execution environment according to the MBR and the disk data obtained, and simulating an execution process of the MBR; analyzing and recording a simulated behavior pattern of the MBR during the process of simulating the execution process of the MBR; and identifying a disk boot sector virus via a contrast analysis between the recorded simulated behavior pattern and the known behavior pattern. The solution of the present disclosure has the beneficial effect that a new boot sector virus can be identified timely and accurately.

This application claims priority to and is a continuation application of PCT/CN2013/088142, filed on Nov. 29, 2013 and entitled “METHOD AND DEVICE FOR IDENTIFYING A DISK BOOT SECTOR VIRUS, AND STORAGE MEDIUM”, which claims the benefit of priority to Chinese patent application No. 201310031901.2 titled “METHOD AND DEVICE FOR IDENTIFYING A DISK BOOT SECTOR VIRUS” and filed on Jan. 28, 2013 by Tencent Technology (Shenzhen) Co., Ltd., which are incorporated herein by reference in their entirety.

### FIELD OF THE INVENTION

The present disclosure relates to the field of computer technologies, and in particular, to a method and a device for identifying a disk boot sector virus, and a storage medium.

### BACKGROUND OF THE INVENTION

Generally, the disk boot sector virus refers to a virus that can start earlier than the Windows operating system and bypass the check of the security software by way of infecting a Master Boot Record (MBR), for example, a bootkit virus.

At present, security manufacturers usually find a boot sector virus by checking the local MBR. Generally, at first, various known MBR disk data infected by a boot sector virus are collected as a black sample, and various MBR disk data that are not infected by the boot sector virus are collected as a white sample, and then the collected black sample and white sample are saved in the background server. When an anti-virus software checks the local MBR, it first reads the MBR disk data, obtains the characteristic value of the MBR (for example, md5 value) and uploads the same to the server, such that the obtained characteristic value is compared with an MBR characteristic value of a black sample or a white sample saved on the server. Once it finds that the obtained MBR characteristic value is consistent with that of the known black sample, it regards that the disk boot sector in which the MBR exists is infected by a virus; when it finds that the obtained MBR characteristic value is consistent with that of the white sample, no treatment will be carried out; if it finds that the obtained MBR characteristic value is consistent with neither that of the white sample nor that of the black sample, it will be uploaded as a new sample to determine through manual analysis whether the new sample is a black sample or a white sample.

In the above processing manner, since a large amount of resources are required for storing, comparing and analyzing the characteristic value library, an unknown boot sector virus cannot be actively determined at the user end, and the MBR disk data must be uploaded to the server for analyzing and verifying the existence of the virus, and only then can a treatment be carried out. As a result, the treatment on the boot sector virus is lagged far behind, and the boot sector virus cannot be intercepted in time. Besides, because some viruses can evolve rapidly and various versions can be derived from an MBR successively, the characteristic value will be updated and changed continuously, however, in the above processing manner, every evolved version is treated as an unknown virus, and the characteristic value needs to be reanalyzed, which further lags the virus interception. Moreover, the number of MBR samples is large, and thus one-by-one manual analysis is time-consuming, and some samples might be left out.

### SUMMARY OF THE INVENTION

Therefore, it is a main object of the present disclosure to provide a method and a device for identifying a disk boot sector virus, and a storage medium, to thereby solve the problem that a new boot sector virus cannot be identified timely and accurately.

One embodiment of the present disclosure provides a method for identifying a disk boot sector virus, which method comprises steps of:

obtaining a known behavior pattern that is prestored, and obtaining a master boot record (MBR) and the disk data called when the MBR is executed;

establishing a simulated execution environment according to the obtained MBR and disk data, and simulating an execution process of the MBR;

analyzing and recording a simulated behavior pattern of the MBR during the process of simulating the execution process of the MBR; and

identifying a disk boot sector virus via a contrast analysis between the recorded simulated behavior pattern and the known behavior pattern.

One embodiment of the present disclosure further provides a device for identifying a disk boot sector virus, which comprises:

a data obtaining module, for obtaining a known behavior pattern that is prestored and obtaining a master boot record (MBR) and the disk data called when the MBR is executed;

a simulation executing module, for establishing a simulated execution environment according to the obtained MBR and disk data, simulating an execution process of the MBR, and analyzing and recording a simulated behavior pattern of the MBR during the process of simulating the execution process of the MBR; and

a virus identifying module, for identifying a disk boot sector virus via a contrast analysis between the recorded simulated behavior pattern and the known behavior pattern.

One embodiment of the present disclosure further provides a storage medium containing computer-executable instructions, with the computer-executable instructions being configured to execute a method for identifying a disk boot sector virus, and the method comprises steps of:

obtaining a known behavior pattern that is prestored, and obtaining a master boot record (MBR) and the disk data called when the MBR is executed;

establishing a simulated execution environment according to the obtained MBR and disk data, and simulating an execution process of the MBR;

analyzing and recording a simulated behavior pattern of the MBR during the process of simulating the execution process of the MBR; and

identifying a disk boot sector virus via a contrast analysis between the recorded simulated behavior pattern and the known behavior pattern.

By a method comprising the steps of: obtaining a known behavior pattern that is prestored, and obtaining a master boot record (MBR) and the disk data called when the MBR is executed; establishing a simulated execution environment according to the obtained MBR and disk data, and simulating an execution process of the MBR; analyzing and recording a simulated behavior pattern of the MBR during the process of simulating the execution process of the MBR; and identifying a disk boot sector virus via a contrast analysis between the recorded simulated behavior pattern and the known behavior pattern, the present disclosure has the beneficial effect that a new boot sector virus can be identified timely and accurately, the boot sector virus identified can be responded to and processed in time, and the processing speed in processing the boot sector virus can be increased.

### BRIEF DESCRIPTION OF THE DRAWINGS

In order to clearly illustrate technical solutions of embodiments of the present disclosure, drawings needed in the description of the embodiments will be briefly introduced below. However, the drawings in the description below are only some embodiments of the present disclosure, and modifications and substitutions can be made to these drawings by those skilled in the art without any creative work.

FIG. 1 is a schematic flow chart of a method for identifying a disk boot sector virus according to the first embodiment of the present disclosure;

FIG. 2 is a schematic diagram showing the functional modules on a server when a method for identifying a disk boot sector virus according to the second embodiment of the present disclosure is applied to the server;

FIG. 3 is a schematic flow chart when the method for identifying the disk boot sector virus according to the second embodiment of the present disclosure is applied to the server;

FIG. 4 is a schematic diagram showing the functional modules on a client when a method for identifying a disk boot sector virus according to the third embodiment of the present disclosure is applied to the client;

FIG. 5 is a schematic flow chart when the method for identifying the disk boot sector virus according to the third embodiment of the present disclosure is applied to the client;

FIG. 6 is a schematic diagram showing the functional modules of a device for identifying a disk boot sector virus according to the fourth embodiment of the present disclosure;

FIG. 7 is a schematic diagram of the functional modules when a device for identifying a disk boot sector virus according to the fifth embodiment of the present disclosure is applied to a server; and

FIG. 8 is a schematic diagram of the functional modules when a device for identifying a disk boot sector virus according to the sixth embodiment of the present disclosure is applied to a client.

The realization of the objects, the functional characteristics and the advantages of the present disclosure will be further illustrated in conjunction with the embodiments by referring to the accompanying drawings.

### DETAILED DESCRIPTION OF THE EMBODIMENTS

Hereinafter, technical solutions in embodiments of the present disclosure will be described clearly and completely in conjunction with the accompanying drawings. Apparently, the embodiments described are only a part of the embodiments of the present disclosure, rather than being the whole embodiments; and the embodiments described are used to explain the principle of the present disclosure, rather than limiting the present disclosure to these specific embodiments. Other embodiments obtained by one of ordinary skills in the art based on the embodiments of the present disclosure without creative work should all fall within the protection scope of the present disclosure.

The technical solutions of the present application will be further illustrated below in conjunction with the drawings and specific embodiments in the specification. It should be understood that the specific embodiments described herein are only used to explain the present disclosure, rather than limiting the present disclosure.

MBR is the first sector that a computer must read when it accesses the disk after being started up. During the execution process of the MBR, the disk data in the MBR will be executed, and at the same time, the disk data at other locations of the disk will be called, such that the start process of the operating system of the computer will be completed. In the method and device for identifying a disk boot sector virus according to the present disclosure, a simulated boot is performed by employing the disk data called when the MBR is executed as a virtual disk under the premise that the actual computer system is not influenced, and all the behaviors during the boot of the simulation system will be analyzed and recorded, to determine whether the disk data in the MBR have a suspicious behavior. The above simulation execution process may be executed on a server or on a client. When the simulation execution process is executed on a server, a large amount of MBR disk data may be picked up as samples, and each MBR data includes the disk data in the MBR and the disk data that needs to be called during the execution process thereof. The server may process the large amount of MBR data in batches, such that MBR disk data having a virus behavior and MBR disk data obviously having no any suspicion can be separated automatically, meanwhile a few samples that cannot be verified by automatic analysis is left, and the samples that cannot be verified by automatic analysis is marked as samples that require manual analysis to remind a background developer or analyzer to perform manual analysis. When the simulation execution process is executed on a client, at the time the client finds that the disk boot sector in which the local MBR exists is infected by an unknown virus, for example, the bootkit virus, it will perform the intercepting and restoring processes in time, mark the MBR disk data infected by the virus as a black sample and upload the same to the server. When no conclusion can be drawn from the traditional comparison between black and white samples, in comparison with the typical method for identifying a disk boot sector virus, with the method and device for identifying a disk boot sector virus according to the present disclosure, the analysis efficiency of the MBR data can be improved, and a new virus in the disk boot sector can be found in advance.

### First Embodiment

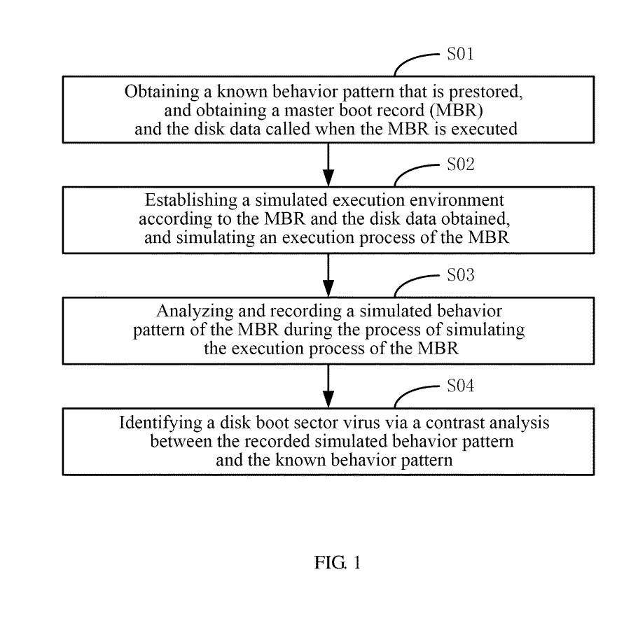

Referring to FIG. 1, FIG. 1 is a schematic flow chart of a method for identifying a disk boot sector virus according to the first embodiment of the present disclosure. As shown in FIG. 1, the method for identifying the disk boot sector virus according to the present disclosure includes the following Steps S01-S04.

Step S01: obtaining a known behavior pattern that is prestored, and obtaining a master boot record (MBR) and the disk data called when the MBR is executed.

Whether the identification method is applied to a server or a client, some known behavior patterns may be obtained in advance as an analytical standard. The known behavior pattern may be a behavior pattern corresponding to a white sample, or a behavior pattern corresponding to a black sample, or a behavior pattern corresponding to a typical boot sector virus. The known behavior pattern may be typically obtained by analyzing the black sample and white sample via a server.

For example, because the server has collected in advance various MBR disk data infected by known boot sector viruses as black samples and various MBR disk data that are not infected by boot sector viruses as white samples, and the black samples and white samples collected are both saved on the server, when performing the identifying of a disk boot sector virus, the above known behavior patterns that are prestored may be obtained by simulating the execution of the disk data of the black samples and white samples in advance and performing contrast analysis according to the above saved black samples and white samples. The known behavior pattern may be one behavior pattern, or a group of multiple behavior patterns with a set sequence or without a set sequence. The known behavior pattern obtained in advance may be stored on the server, or they may be provided by the server to the client for prestoring, or they may be provided by the server to the client in real time when the client needs to perform the behavior analysis.

The known behavior pattern corresponding to the boot sector virus of the black sample may include a special behavior pattern during the boot process of some boot sector viruses, which are concluded when manually analyzing a boot sector virus such as the bootkit virus. It may be understood by one skilled in the art that, the special behavior pattern during the boot process of some boot sector viruses includes, but is not limited to: modifying the amount of system memory so as to leave an available memory space for the boot sector virus itself, and hooking int 13 interruption, etc.

At the same time, an MBR and the disk data called when the MBR is executed are obtained in this step, to make preparation for the subsequent establishment of a simulated execution environment. Preferably, the step of obtaining the MBR and the disk data called when the MBR is executed comprises obtaining an MBR and obtaining a set number of data in a disk which are located at the disk header, the disk tail and the first active partition indicated in the MBR, for example, data each has a size of 1 M, as the disk data called when the MBR is executed. Generally, the disk data determined in the above manner can cover all the disk data that need to be called, and the data volume thereof will not be too large, and thus no computational resources will be occupied.

In one preferred embodiment, a few samples which cannot be verified by automatic analysis may be analyzed manually, and the behavior pattern of a new virus obtained may be stored on the server, such that the analysis precision of the method for identifying the disk boot sector virus can be increased continuously.

Step S02: establishing a simulated execution environment according to the MBR and disk data obtained, and simulating an execution process of the MBR.

In this step, a basic simulated execution environment, for example, a memory, etc., may be established on the client or the server in advance, after the MBR and the disk data called by the MBR are obtained, some parameters of the simulated execution environment may be adjusted accordingly, to thereby prepare an execution environment for the current simulated execution.

Step S03: analyzing and recording a simulated behavior pattern of the MBR during the process of simulating the execution process of the MBR.

After the initialization and power-on self check of the Basic Input Output System (BIOS) of the client, a system self check program is started to check the MBR and execute instructions contained in the MBR, such that the starting of the windows system is booted by the instructions. Since the disk boot sector virus is a virus that can start earlier than the operating system by way of infecting the MBR and can bypass the check of the client security software, a virtual simulated execution environment may be established based on the MBR and the disk data called when the MBR is executed that are obtained, to simulate the execution process of the MBR, analyze and record the simulated behavior pattern of the MBR, such that the disk boot sector virus can be identified as early as possible, and corresponding measures can be taken.

A simulated execution environment may be established on the server or the client. The simulated execution means to simulate a hardware execution process by a software resource on the computer, it may also be understood as a technology of simulating the software execution of one computer on another computer. At present, there are various typical simulated execution modes, for example, the interpretive execution mode in which each instruction is decoded, and the behavior of each instruction is simulated via a software resource; or the simulated execution is performed by using the VT technology (a virtual technology supported by x86 chip hardware from Intel), for example, the open-source software Bochs which is a virtual machine of an x86 hardware platform and is similar to virtual machines VMWare and VirtualBox. Since Bochs also simulates all hardwares, the operating of Bochs will not influence the data in the actual disk of the computer itself, and no driver program will be loaded to the local computer by the Bochs. Thus the Bochs is a pure application.

In the present embodiment, a virtual disk environment can be established after the MBR and the disk data called by the MBR are obtained. When the simulated execution is performed in the virtual disk environment, the instructions contained in the MBR can be executed and the disk data can be called. Thereby, the behavior pattern during the execution process can be obtained.

In one preferred embodiment, the method for identifying the disk boot sector virus according to the present disclosure employs the interpretive execution as a preferred mode of the simulated execution. When the simulated execution is performed in the interpretive execution mode, no instruction is actually executed; instead, each instruction is decoded, and the behavior thereof is read to perform the virtual execution. For example, when a “read-write register” is simulated, a read-write virtual register (for example, some variables defined in C language) is actually executed; when a “read-write memory” is simulated, a data array is actually operated; when an “Input/Output (IO) operation” is simulated, it actually interacts with some virtual devices, while these virtual devices are some data structures and software programs supporting the operation of the data structures that are written in C language; and when “interruption” is simulated, it actually inserts some asynchronous events during the execution process of an instruction.

Step S04: identifying a disk boot sector virus via a contrast analysis between the recorded simulated behavior pattern and the known behavior pattern.

In this step, all the simulated behavior patterns during the whole start process may be obtained. Preferably, during the simulation execution process, the simulated behavior patterns are obtained sequentially and are analyzed in real time. When it can be verified, via a certain simulated behavior pattern or some simulated behavior patterns, that the MBR disk data has been or has not been infected by a boot sector virus, the simulation execution process can be stopped so as to save the operation resource.

There are various manners for performing the contrast analysis between the simulated behavior pattern recorded and the known behavior pattern. For example, if the recorded simulated behavior pattern is consistent with the known behavior pattern of a prestored MBR white sample, it will be identified that the disk boot sector in which the MBR exists is not infected by a boot sector virus thus far. If the recorded simulated behavior pattern matches the known behavior pattern of the prestored boot sector virus, or the recorded simulated behavior pattern is consistent with the known behavior pattern of a prestored MBR black sample, or some apparent behavior patterns of a boot sector virus (for example, modifying the amount of system memory so as to leave an available memory space for itself, hooking int 13 interruption, accessing the end part of the disk space, etc.) exist in the simulated behavior patterns, it will be identified that the disk boot sector in which the MBR exists corresponding to the simulated behavior pattern has been infected by a virus, and the corresponding disk data called when the MBR is executed will be marked as a black sample.

Another preferred realization mode is as follows: when a set number of simulated behavior patterns recorded match a known behavior pattern of a black sample, matching the simulated behavior pattern set in each simulated behavior pattern, which matches the known behavior pattern of the black sample, with a known behavior pattern of a white sample; when the simulated behavior pattern that is set does not match the known behavior pattern of the white sample, identifying that the disk boot sector in which the MBR exists has been infected by a virus, and marking the disk data called when the MBR is executed as a black sample. This solution is applicable to behavior patterns of some special white samples. When it is identified that one or more simulated behavior patterns are consistent with the known behavior pattern of a preset black sample, it should have been determined that the MBR disk data is a black sample, however, in fact, there may exist some special white samples whose behavior patterns are partially the same as the behavior pattern of a black sample. Therefore, after a behavior pattern is preliminarily determined to be the behavior pattern of a black sample, some special simulated behavior patterns can be excluded by matching a preset simulated behavior pattern with the known behavior pattern of a white sample that is set. With this solution, the accuracy in identifying whether an MBR has been infected by a virus can be further improved.

It may be understood by one skilled in the art that, because MBR is smallish (in fact, only 512 bytes), even if more instructions may be loaded to perform virus operations after an the MBR is infected by a virus, the time of the MBR execution process is still short and the number of instructions executed is small, therefore it is easy to separate some behavior patterns with apparent virus characteristics because a normal system boot process does not have these behavior patterns. Thereby, the system resources and time required to simulate the above process are relatively small.

In the method according to embodiments of the present disclosure, by obtaining a known behavior pattern that is prestored, an MBR and the disk data called when the MBR is executed, and preferably, obtaining the known behavior pattern of a prestored boot sector virus; establishing a simulated execution environment based on the obtained MBR and disk data, simulating the execution process of the MBR, and analyzing and recording the simulated behavior pattern of the MBR; and comparing the recorded simulated behavior pattern with the known behavior pattern and analyzing the same, a disk boot sector virus can be identified. Therefore, the method has an advantageous technical effect that a new boot sector virus can be identified timely and accurately. Since there may exist the same behavior patterns when MBRs infected by different viruses are executed, by identifying the behavior pattern to decide whether an MBR is infected by a virus, the embodiment of the present disclosure is applicable for identifying more boot sector viruses, without the need of updating at a high frequency with the change of virus infected. Moreover, because the computational resource occupied by the MBR simulated execution is small, the client can also perform the virus identification process, and it is no need to be upload to the server. Therefore the client can respond to and process an identified virus in time.

### Second Embodiment

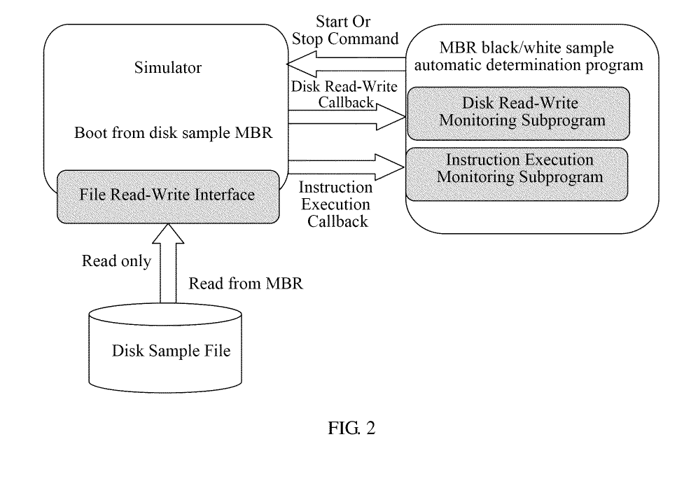

The method for identifying a disk boot sector virus according to the second embodiment of the present disclosure is based on the above embodiment, and specifically, it is an embodiment in which the method for identifying the disk boot sector virus is applied to a server. Referring to FIG. 2, FIG. 2 is a schematic diagram showing the functional modules on a server when the method for identifying the disk boot sector virus according to the second embodiment of the present disclosure is applied to the server. As shown in FIG. 2, when the method for identifying the disk boot sector virus is applied to the server, the MBR and the disk data called when the MBR is executed are disk sample files read by the server. Generally, the read starts from the MBR to perform the boot. The disk sample files are disk data samples collected by the server from the client. During the simulated execution, a simulator on the server starts to read related disk data from the MBR in the above disk sample files via a file read-write interface, performs a read operation on the above disk sample files, and records the write operation on the above disk sample files and the written specific content as a part of its behavior pattern. But it is preferable that no write operation is performed on the disk sample file so as to protect the disk sample file from being modified. With an interactive operation between the simulator on the server and an MBR black/white sample automatic determination program, the identifying of the disk boot sector viruses is implemented on the server. The MBR black/white sample automatic determination program can obtain a simulated behavior pattern. Typically, a disk read-write behavior and an instruction execution behavior are obtained via the disk read-write callback and instruction execution callback. A behavior analysis is performed on the MBR black/white sample automatic determination program in a disk read-write monitoring subprogram and an instruction execution monitoring subprogram, respectively. The MBR black/white sample automatic determination program may send a simulation start instruction to the simulator, and may also send a simulation stop instruction to the simulator after it is determined by analysis that the MBR disk data has been infected by a virus.

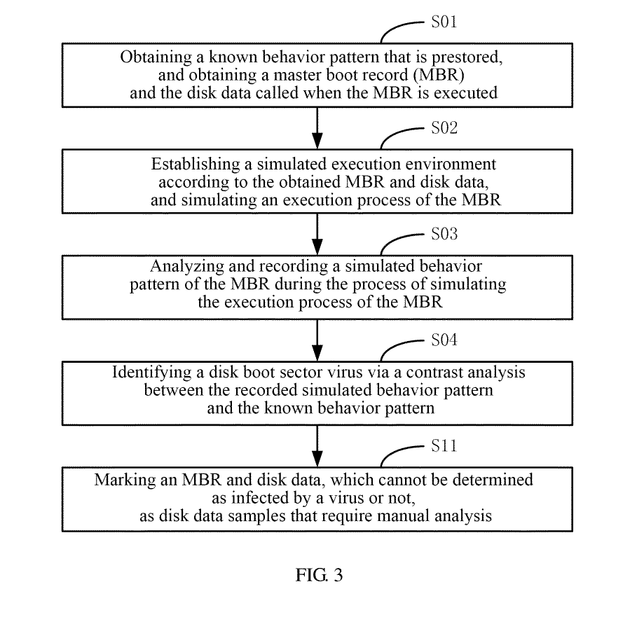

In conjunction with the embodiments shown in FIG. 1 and FIG. 2, referring to FIG. 3, FIG. 3 is a schematic flow chart when the method for identifying the disk boot sector virus according to the second embodiment of the present disclosure is applied to the server. The difference between the present embodiment and the embodiment of FIG. 1 lies only in that a Step S11 is added. In the present embodiment, only Step S11 is specifically described, and for other steps concerned in the method for identifying the disk boot sector virus according to the present disclosure, reference may be made to the specific description of the above related embodiments, and they will not be described again here.

As shown in FIG. 3, after Step S04, that is, identifying a disk boot sector virus via a contrast analysis between the recorded simulated behavior pattern and the known behavior pattern, the method for identifying the disk boot sector virus according to the present disclosure further includes the following step:

Step S11: marking an MBR and disk data that cannot be determined on whether having been infected by a virus as disk data samples that require manual analysis.

The server performs a contrast analysis between the recorded simulated behavior pattern and the stored known behavior pattern, and for the simulated behavior pattern that matches the known behavior pattern of the white sample, it will be identified that the corresponding MBR disk data has no security threat thus far; for the simulated behavior pattern that matches the known behavior pattern of the black sample or the behavior pattern of some apparent boot sector viruses, it will be identified that the corresponding MBR disk data have been infected by a boot sector virus; while for the simulated behavior pattern that matches neither the white sample nor the black sample and cannot be identified on whether the recorded simulated behavior pattern is a behavior pattern of an apparent boot sector virus, a prompting message will be issued to the client to remind the client to perform a manual analysis on the MBR and the disk data corresponding to the simulated behavior pattern, such that it can be identified in time whether the MBR corresponding to the simulated behavior pattern has been infected by a virus, and corresponding measures may be adopted in time. In actual operation, all or a part of the MBR and the disk data may be marked, as required, as disk data samples that require manual analysis, such that it can be selected for manual analysis.

### Third Embodiment

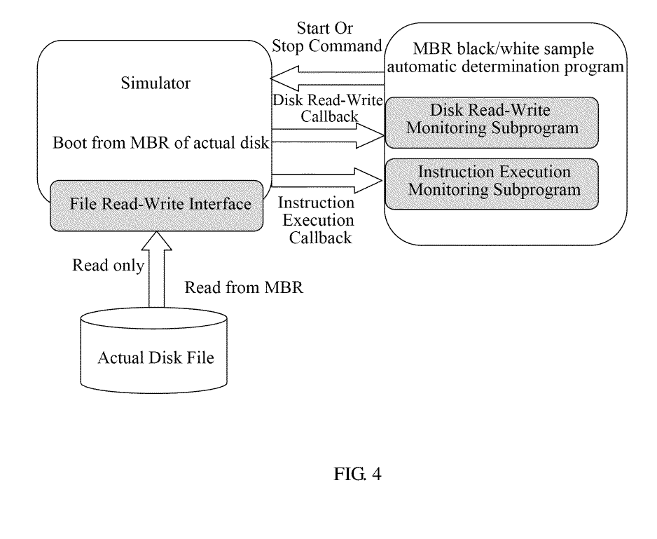

The method for identifying a disk boot sector virus according to the third embodiment of the present disclosure is based on the above embodiment, and specifically, it is a realization manner that is applied to a client. Referring to FIG. 4, FIG. 4 is a schematic diagram showing the functional modules on a client when a method for identifying a disk boot sector virus according to the third embodiment of the present disclosure is applied to the client. As shown in FIG. 4, when the method for identifying the disk boot sector virus is applied to the client, the MBR and the disk data are actual disk files on the client read by the client from the MBR of its actual disk. During the simulated execution, a simulator on the client starts to read the disk data from the actual disk MBR on the actual disk of the client, performs a read operation on the above disk files, and records the write operation on the above disk sample files and the specific content written as a part of its behavior patterns. Similarly, it is preferred that no write operation is directly performed on an actual disk file so as to prevent the file from being modified. With an interactive operation between the simulator on the client and the MBR black/white sample automatic determination program, the identifying of the disk boot sector virus on the client is completed.

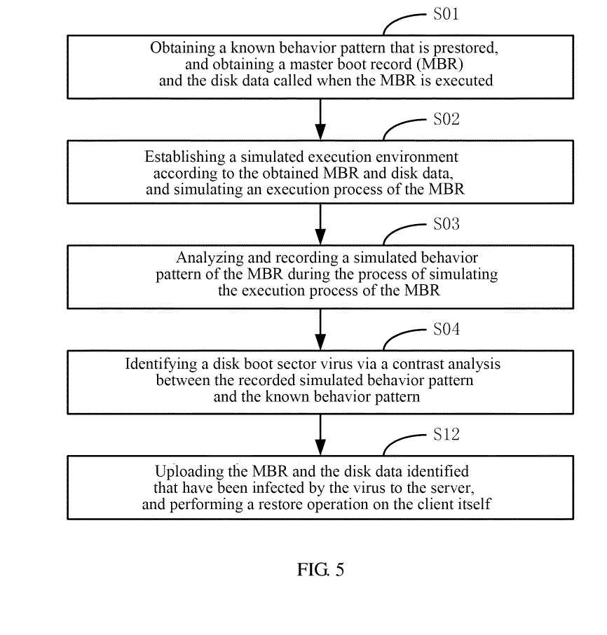

Referring to FIG. 5 in conjunction with the embodiments shown in FIG. 1 and FIG. 4, FIG. 5 is a schematic flow chart when the method for identifying the disk boot sector virus according to the third embodiment of the present disclosure is applied to a client. The difference between the present embodiment and the embodiment of FIG. 1 lies only in that a Step S12 is added. In the present embodiment, only Step S12 will be specifically described, and for other steps concerned in the method for identifying the disk boot sector virus according to the present disclosure, reference may be made to the specific description of the above related embodiments, and thus they will not be described again here.

As shown in FIG. 5, after Step S04, that is, identifying a disk boot sector virus via a contrast analysis between the recorded simulated behavior pattern and the known behavior pattern, the method for identifying the disk boot sector virus according to the present disclosure further includes the following step:

Step S12: uploading the MBR and the disk data identified having been infected by the virus to the server, and performing a restore operation on the client itself.

Generally, the MBR and the disk data identified having been infected by the virus are marked as disk data of a black sample. The client performs a contrast analysis between a recorded simulated behavior pattern and a known behavior pattern stored, and for a simulated behavior pattern that matches the known behavior pattern of a white sample, it is identified that the corresponding MBR disk data has no security threat thus far; for a simulated behavior pattern that matches the known behavior pattern of a black sample or a behavior pattern of some apparent boot sector viruses, it is identified that the corresponding MBR disk data have been infected by a boot sector virus. Then the client uploads the disk data marked as a black sample to the server and performs the restore operation on itself.

In one preferred embodiment, for a simulated behavior pattern that matches neither a white sample nor a black sample, it is uploaded to the server, and the server analyzes the simulated behavior pattern and matches the same with the stored black and white samples; if the simulated behavior pattern cannot be verified even after being analyzed by the server, it will be analyzed by a background analyzer, and be processed according to the analysis result. For example, if the analysis result of the client is that the simulated behavior pattern is a secure behavior, it will not be processed; if the analysis result is that the simulated behavior pattern will cause a security threat on the client, the disk data corresponding to the simulated behavior pattern will be deleted, restored, etc., and the above analysis result and processing procedure will be uploaded to the server. According to the analysis result, the client may mark the disk data corresponding to a secure behavior as a white sample, and mark the disk data that cause a security threat on the client as a black sample, and then upload the white sample and the black sample to the server.

In the present embodiment, after the client identifies a boot sector virus, it performs a restore operation on itself, thus it has a beneficial effect that a boot sector virus identified can be responded to and processed in time, which therefore increases the processing speed in processing the boot sector virus on the client.

### Fourth Embodiment

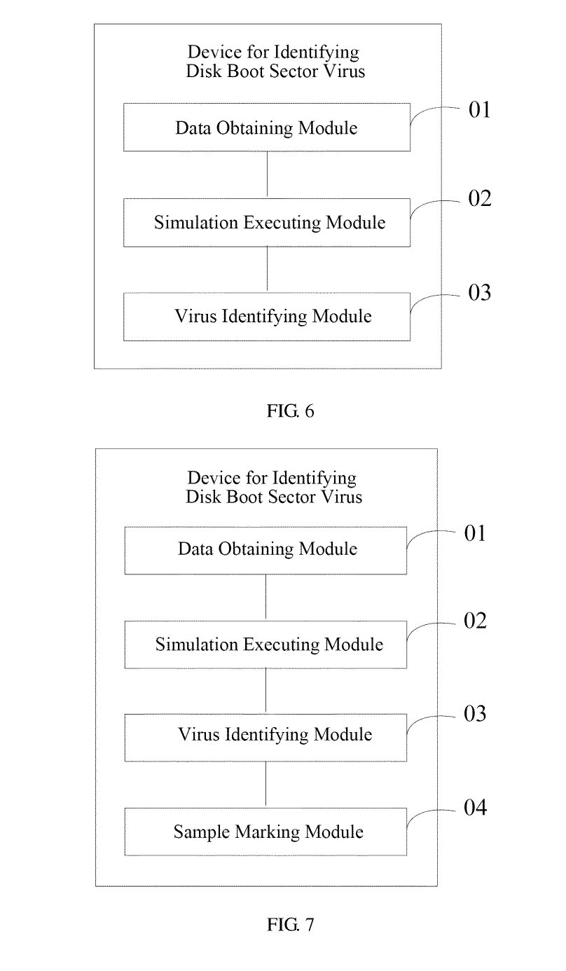

Referring to FIG. 6, FIG. 6 is a schematic diagram showing the functional modules of a device for identifying a disk boot sector virus according to the fourth embodiment of the present disclosure. As shown in FIG. 6, the device for identifying a disk boot sector virus according to the present disclosure includes: a data obtaining module 01, a simulation executing module 02 and a virus identifying module 03.

The data obtaining module 01 is configured to obtain a known behavior pattern that is prestored and obtain a master boot record (MBR) and the disk data called when the MBR is executed.

Because the server has, in advance, collected various MBR disk data that have been infected by known boot sector viruses as black samples and various MBR disk data that are not infected by boot sector viruses as white samples, and the above collected black samples and white samples are saved on the server, when identifying a disk boot sector virus, the data obtaining module 01 may obtain the above prestored known behavior patterns by simulating the execution of the disk data of the black samples and white samples in advance and performing contrast analysis according to the above saved black samples and white samples. The known behavior pattern may be a behavior pattern corresponding to a black sample or a white sample, or a known behavior pattern of a typical boot sector virus. The known behavior pattern of the boot sector virus includes the special behavior patterns during the boot process of some boot sector viruses, which are concluded when manual analysis is performed on a boot sector virus such as bootkit. It may be understood by one skilled in the art that, the special behavior patterns during the boot process of some boot sector viruses include, but are not limited to: modifying the amount of system memory so as to leave an available memory space for itself, and hooking int 13 interruption, etc. At the same time, the data obtaining module 01 obtains an MBR and the disk data called when the MBR is executed, which makes preparations for the subsequent establishment of a simulated execution environment. In one preferred embodiment, for a few samples that cannot be verified by automatic analysis, manual analysis may be performed and the behavior pattern of a new virus obtained may be stored on the server, such that the precision of the device for identifying the disk boot sector virus in analyzing the boot sector virus can be increased continuously.

The simulation executing module 02 is configured to establish a simulated execution environment according to the MBR and the disk data obtained, simulate an execution process of the MBR, and analyze and record a simulated behavior pattern of the MBR during the process of simulating the execution process of the MBR.

After the BIOS of a client performs the initialization and power-on self check, a system self check program is started, the MBR is checked and the instruction contained in the MBR is executed, and then the starting of the windows system is booted by these instructions. Since the disk boot sector virus is a virus that can start earlier than the operating system by way of infecting the MBR and bypass the check of the client security software, the simulation executing module 02 may establish a virtual simulated execution environment according to the MBR and the disk data called when the MBR is executed that are obtained by the data obtaining module 01, to simulate the execution process of the MBR, analyze and record the simulated behavior pattern of the MBR, such that the disk boot sector virus can be identified as soon as possible and corresponding measures can be taken.

It may be understood by one skilled in the art that, because MBR is smallish (in fact, it is only 512 bytes), even if more instructions may be loaded to perform the virus operation after the MBR is infected by a virus, the time of the execution process is still short and the number of instructions executed is small. Therefore it is easy to separate some behavior patterns with apparent virus characteristics because these behavior patterns do not exist in a normal system boot process. Thereby, the system resource and time required to simulate the above process are relatively small.

For the description related to the simulated execution, reference may be made to the specific description of the above related embodiment, which will not be described again here.

In one preferred embodiment, the device for identifying the disk boot sector virus according to the present disclosure employs the interpretive execution as a preferred realization manner of the simulated execution. When performing the simulated execution in the interpretive execution manner, no instruction is actually executed. Instead, each instruction is decoded, and the behavior thereof is read to perform the virtual execution. For example: when simulating the “read-write register”, a read-write virtual register (for example, some variables defined in C language) is actually executed; when simulating the “read-write memory”, a data array is actually operated; when simulating an “IO operation”, it actually interacts with some virtual devices, while these virtual devices are some data structures and software programs supporting the operation thereof that are written in C language; and when simulating the “interruption”, it actually inserts some asynchronous events during the execution process of the instruction.

The virus identifying module 03 is configured to identify a disk boot sector virus via a contrast analysis between the simulated behavior pattern recorded and the known behavior pattern.

The virus identifying module 03 performs a contrast analysis between the simulated behavior pattern recorded by the simulation executing module 02 and the known behavior pattern obtained by the data obtaining module 01, if the recorded simulated behavior pattern is consistent with the known behavior pattern of a prestored white sample, it will be identified by the virus identifying module 03 that the corresponding disk boot sector is not infected by a boot sector virus thus far; if the recorded simulated behavior pattern matches the known behavior pattern of the prestored boot sector virus, or the recorded simulated behavior pattern matches the known behavior pattern of a prestored black sample, or there exist some behavior patterns of an apparent boot sector virus (for example, modifying the amount of the system memory so as to leave an available memory space for itself, hooking int 13 interruption, accessing the end part of the disk space, etc.), it will be identified by the virus identifying module 03 that the disk boot sector corresponding to the simulated behavior pattern has been infected by a virus, and the corresponding disk data called when the MBR is executed will be marked as a black sample.

Preferably, the virus identifying module 03 may further be configured to perform the following operations of: when a set number of simulated behavior patterns recorded match a known behavior pattern of a black sample, matching the simulated behavior pattern set in each simulated behavior pattern, which matches the known behavior pattern of the black sample, with a known behavior pattern of a white sample; and when the simulated behavior pattern that is set does not match the known behavior pattern of the white sample, identifying that a disk boot sector in which the MBR exists has been infected by a virus and marking the disk data called when the MBR is executed as a black sample. In the above solution, behavior patterns of special white samples can be excluded effectively, therefore misjudgement can be avoided.

By obtaining a known behavior pattern that is prestored, an MBR and the disk data called when the MBR is executed, especially obtaining the known behavior pattern of a boot sector virus in advance; establishing a simulated execution environment according to the MBR and the disk data obtained, simulating the execution process of the MBR, and analyzing and recording the simulated behavior pattern of the MBR; and identifying a disk boot sector virus via a contrast analysis between the simulated behavior pattern recorded and the known behavior pattern, the present embodiment has the beneficial effect that a new boot sector virus can be identified timely and accurately.

### Fifth Embodiment

Referring to FIG. 7 in conjunction with the embodiments shown in FIG. 2 and FIG. 6. FIG. 7 is a schematic diagram of the functional modules when a device for identifying a disk boot sector virus according to the fifth embodiment of the present disclosure is applied to a server. The difference between the present embodiment and the embodiment of FIG. 6 lies only in that a sample marking module 04 is added. Thus, in the present embodiment, only the sample marking module 04 will be specifically described, and for other modules concerned in the device for identifying the disk boot sector virus according to the present disclosure, reference may be made to the specific description of the related embodiments, which will not be described again here.

As shown in FIG. 7, when the device for identifying the disk boot sector virus according to the present disclosure is applied to the server, the MBR and the disk data are disk data samples of the client that are collected by the server. Preferably, the device further includes: a sample marking module 04, for marking the MBR and the disk data as disk data samples that require manual analysis.

Preferably, the sample marking module 04 is configured for marking an MBR and disk data, which cannot be determined on whether having being infected by a virus or not, as disk data samples that require manual analysis, after identifying a disk boot sector virus via a contrast analysis between the recorded simulated behavior pattern and the known behavior pattern.

The virus identifying module 03 performs a contrast analysis between a simulated behavior pattern recorded by the simulation executing module 02 and a known behavior pattern obtained by the data obtaining module 01. For a simulated behavior pattern that matches a white sample of the known behavior patterns, it will be identified that the corresponding MBR disk data has no security threat thus far; for a simulated behavior pattern that matches a black sample of the known behavior patterns, or if there exist some behavior patterns of an apparent boot sector virus, it will be identified that the corresponding MBR disk data have been infected by a boot sector virus; but for a simulated behavior pattern that matches neither a white sample nor a black sample and cannot be identified on whether the recorded simulated behavior pattern is a behavior pattern of an apparent boot sector virus, the sample marking module 04 issues a prompting message to the client to remind the client to perform a manual analysis on the MBR and the disk data corresponding to the simulated behavior pattern, such that it may be identified in time whether the MBR corresponding to the simulated behavior pattern has been infected by a virus, to thereby take corresponding measures in time.

### Sixth Embodiment

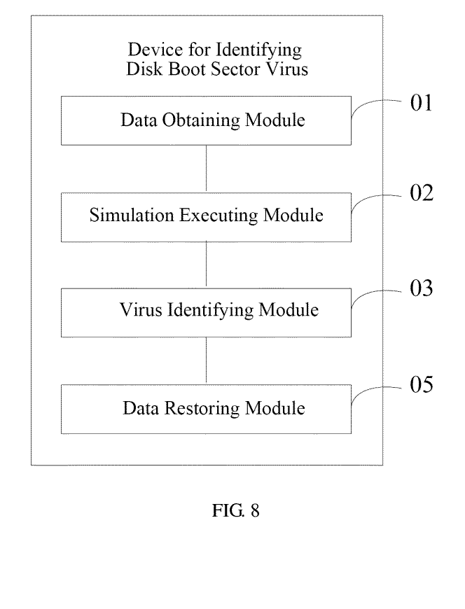

Referring to FIG. 8 in conjunction with the embodiments shown in FIG. 4 and FIG. 6. FIG. 8 is a schematic diagram of the functional modules when a device for identifying a disk boot sector virus according to the sixth embodiment of the present disclosure is applied to the client. The difference between the present embodiment and the embodiment of FIG. 6 lies only in that a data restoring module 05 is added. Thus, in the present embodiment, only the data restoring module 05 will be specifically described, and for other modules concerned in the device for identifying the disk boot sector virus according to the present disclosure, reference may be made to the specific description of the related embodiments, which will not be described again here.

As shown in FIG. 8, when the device for identifying the disk boot sector virus according to the present disclosure is applied to the client, the MBR and the disk data are data read by the client from its own disk. Preferably, the device further includes: a data restoring module 05, for uploading the disk data marked as a black sample to the server and performing a restore operation on the client itself.

Preferably, the data restoring module 05 is configured for performing the following operation of: identifying a disk boot sector virus via a contrast analysis between the recorded simulated behavior pattern and the known behavior pattern, and then uploading the MBR and the disk data, which are identified having been infected by the virus, to the server and performing a restore operation on the client itself,.

The virus identifying module 03 performs a contrast analysis between a simulated behavior pattern recorded by the simulation executing module 02 and a known behavior pattern obtained by the data obtaining module 01. For a simulated behavior pattern that matches a white sample of the known behavior patterns, it will be identified that the corresponding MBR disk data has no security threat thus far; for a simulated behavior pattern that matches a black sample of the known behavior patterns, or some behavior patterns of an apparent boot sector virus, it will be identified that the corresponding MBR disk data have been infected by a boot sector virus. The data restoring module 05 on the client uploads the disk data marked as a black sample to the server and performs a restore operation on itself.

In one preferred embodiment, for a simulated behavior pattern that matches neither a white sample nor a black sample, the data restoring module 05 uploads the above simulated behavior pattern to the server, and the server will analyze the simulated behavior pattern and match it with the stored black and white samples, if the simulated behavior pattern cannot be verified even after the analysis of the server, it will be manually analyzed by a background analyzer, and it will be processed according to the analysis result. For example, if the analysis result shows that the simulated behavior pattern is a secure behavior, it will not be processed by the data restoring module 05; if the analysis result shows that the simulated behavior pattern will cause a security threat on the client, the disk data corresponding to the simulated behavior pattern will be deleted and restored, etc., by the data restoring module 05, and the above analysis result and processing procedure will be uploaded to the server. According to the analysis result, the data restoring module 05 may mark the disk data corresponding to the secure behavior as a white sample, and mark the disk data that cause a security threat on the client as a black sample, and then upload the white sample and the black sample to the server.

In the present embodiment, after the client identifies a boot sector virus, it performs a restore operation on itself, thus a boot sector virus identified will be responded to and processed in time, and the processing speed in processing the boot sector virus of the client can be increased.

One embodiment of the present disclosure further provides a storage mediums containing computer-executable instructions. The computer-executable instructions are configured for executing a method for identifying a disk boot sector virus when being executed by a computer processor, and the method includes: obtaining a known behavior pattern that is prestored, and obtaining a master boot record (MBR) and the disk data called when the MBR is executed;

establishing a simulated execution environment according to the obtained MBR and the disk data, and simulating the execution process of the MBR;

analyzing and recording a simulated behavior pattern of the MBR during the process of simulating the execution process of the MBR; and

identifying a disk boot sector virus via a contrast analysis between the recorded simulated behavior pattern and the known behavior pattern.

When the executable instructions stored in the storage medium containing computer-executable instructions are executed by a computer processor, the method for identifying the disk boot sector virus according to any embodiment of the present disclosure is performed.

With the description of the above embodiments, one skilled in the art may clearly understand that the present disclosure can be implemented by the aid of softwares and necessary universal hardwares. Of course, the present disclosure CAN be implemented by hardwares. However, in many cases, the former is preferred. Based on this understanding, the essential part of the technical solutions of the present disclosure, or in other words, the part that contributes to the prior art, can be embodied in the form of a software product. The computer software product is stored in a computer-readable storage medium, for example, floppy disk, Read-Only Memory (ROM), Random Access Memory (RAM), FLASH, hard disk or compact disc, etc. of a computer, and includes several instructions driving a computer device (which may be a personal computer, a server or a network device, etc.) to implement the methods according to various embodiments of the present disclosure.

The above description only illustrates some preferred embodiments of the present disclosure, and they are not used to limit the protection scope of the present disclosure. All equivalent structures or equivalent flow transformations which are made by utilizing the contents of the specification and drawings of the present disclosure are included in the protection scope of the present disclosure when being directly or indirectly applied to other related technical fields. Various variations and substitutions made readily by one skilled in the art in the technical scope disclosed by the present disclosure all fall into the protection scope of the present disclosure. Therefore, the protection scope of the present disclosure is defined by the protection scope of the claims.

What is claimed is:

1. A method for identifying a disk boot sector virus, comprising steps of:
obtaining a known behavior pattern that is prestored, and obtaining a master boot record (MBR) and disk data called when the MBR is executed;
establishing a simulated execution environment according to the obtained MBR and disk data, and simulating an execution process of the MBR;
analyzing and recording a simulated behavior pattern of the MBR during the process of simulating the execution process of the MBR; and
identifying a disk boot sector virus via a contrast analysis between the recorded simulated behavior pattern and the known behavior pattern.

2. The method according to claim 1, wherein the step of identifying the disk boot sector virus via the contrast analysis between the recorded simulated behavior pattern and the known behavior pattern comprises:
when the recorded simulated behavior pattern matches a known behavior pattern of a black sample or a boot sector virus, identifying that a disk boot sector in which the MBR exists has been infected by a virus, and marking the disk data called when the MBR is executed as a black sample,.

3. The method according to claim 1, wherein the step of identifying the disk boot sector virus via the contrast analysis between the recorded simulated behavior pattern and the known behavior pattern comprises:
when a set number of simulated behavior patterns that are recorded match a known behavior pattern of a black sample, matching a simulated behavior pattern set in each simulated behavior pattern, which matches the known behavior pattern of the black sample, with a known behavior pattern of a white sample; and
when the set simulated behavior pattern does not match the known behavior pattern of the white sample, identifying that a disk boot sector in which the MBR exists has been infected by a virus, and marking the disk data called when the MBR is executed as a black sample.

4. The method according to claim 1, wherein when the method is applied to a server, the MBR and the disk data are disk data samples of a client that are collected by the server.

5. The method according to claim 2, wherein when the method is applied to a server, the MBR and the disk data are disk data samples of a client that are collected by the server.

6. The method according to claim 3, wherein when the method is applied to a server, the MBR and the disk data are disk data samples of a client that are collected by the server.

7. The method according to claim 4, wherein after the step of identifying the disk boot sector virus via the contrast analysis between the recorded simulated behavior pattern and the known behavior pattern, the method further comprises:
marking an MBR and disk data, which cannot be determined on whether having been infected by a virus or not, as disk data samples that require manual analysis.

8. The method according to claim 1, wherein when the method is applied to a client, the MBR and the disk data are data read by the client from its own disk.

9. The method according to claim 2, wherein when the method is applied to a client, the MBR and the disk data are data read by the client from its own disk.

10. The method according to claim 3, wherein when the method is applied to a client, the MBR and the disk data are data read by the client from its own disk.

11. The method according to claim 8, wherein after the step of identifying the disk boot sector virus via the contrast analysis between the recorded simulated behavior pattern and the known behavior pattern, the method further comprises:
uploading the MBR and the disk data identified having been infected by the virus to the server, and performing a restore operation on the client itself.

12. The method according to claim 1, wherein the step of obtaining the MBR and the disk data called when the MBR is executed comprises:
obtaining an MBR; and
obtaining a set number of data in a disk, which data are located at the disk header, the disk tail and the first active partition indicated in the MBR, as the disk data called when the MBR is executed.

13. A device for identifying a disk boot sector virus, comprising:
a data obtaining module, for obtaining a known behavior pattern that is prestored and obtaining a master boot record (MBR) and the disk data called when the MBR is executed;
a simulation executing module, for establishing a simulated execution environment according to the obtained MBR and disk data, simulating an execution process of the MBR, and analyzing and recording a simulated behavior pattern of the MBR during the process of simulating the execution process of the MBR; and
a virus identifying module, for identifying a disk boot sector virus via a contrast analysis between the recorded simulated behavior pattern and the known behavior pattern.

14. The device according to claim 13, wherein the virus identifying module is configured for:
identifying that a disk boot sector in which the MBR exists has been infected by a virus and marking the disk data called when the MBR is executed as a black sample, when the recorded simulated behavior pattern matches a known behavior pattern of a black sample or a boot sector virus.

15. The device according to claim 13, wherein the virus identifying module is configured for:
matching a simulated behavior pattern set in each simulated behavior pattern, which matches the known behavior pattern of the black sample, with a known behavior pattern of a white sample when a set number of simulated behavior patterns that are recorded match a known behavior pattern of a black sample; and
identifying that a disk boot sector in which the MBR exists has been infected by a virus and marking the disk data called when the MBR is executed as a black sample, when the set simulated behavior pattern does not match the known behavior pattern of the white sample.

16. The device according to claim 13, wherein when the device is applied to a server, the MBR and the disk data are disk data samples of a client that are collected by the server.

17. The device according to claim 16, further comprising:
a sample marking module, for marking an MBR and disk data, which cannot be determined on whether having been infected by a virus or not, as disk data samples that require manual analysis, after identifying a disk boot sector virus via a contrast analysis between the recorded simulated behavior pattern and the known behavior pattern.

18. The device according to claim 13, wherein when the device is applied to a client, the MBR and the disk data are data read by the client from its own disk.

19. The device according to claim 18, further comprising:
a data restoring module, for uploading the MBR and the disk data identified having been infected by the virus to the server and performing a restore operation on the client itself, after identifying a disk boot sector virus via a contrast analysis between the recorded simulated behavior pattern and the known behavior pattern.

20. A storage medium containing computer-executable instructions, with the computer-executable instructions being configured to execute a method for identifying a disk boot sector virus, wherein the method comprises steps of:
obtaining a known behavior pattern that is prestored, and obtaining a master boot record (MBR) and disk data called when the MBR is executed;
establishing a simulated execution environment according to the obtained MBR and disk data, and simulating an execution process of the MBR;
analyzing and recording a simulated behavior pattern of the MBR during the process of simulating the execution process of the MBR; and
identifying a disk boot sector virus via a contrast analysis between the simulated behavior pattern recorded and the known behavior pattern.
